(19) United States
(12) Patent Application Publication
(10) Pub. No.: US 2008/0085421 A1
(43) Pub. Date: Apr. 10, 2008

(54) Surface-Treated Light Alloy Member and Method for Manufacturing Same

(76) Inventor: Kazuyuki Oguri, Aichi (JP)

Correspondence Address: KANESAKA BERNER AND PARTNERS LLP, 1700 DIAGONAL RD, SUITE 310, ALEXANDRIA, VA, 22314-2848, US

(21) Appl. No.: 11/794,261

(22) PCT Filed: Dec. 22, 2005
(86) PCT No.: PCT/JP05/23664

§ 371 Date: Jun. 27, 2007

(30) Foreign Application Priority Data
Dec. 28, 2004 (JP) 2004-381551

(51) Int. Cl. B32B 33/00; B24C 1/10; C25D 11/16

(52) U.S. Cl. 428/687; 72/53

(57) ABSTRACT

A surface-treated light alloy member having both favorable fatigue strength and favorable corrosion resistance, and a method for manufacturing such a surface-treated light alloy member are provided. An air stream containing particles having an average particle size of not less than 10 μm and not more than 200 μm is blown onto the surface of a light alloy member at a spray pressure of not less than 0.2 MPa and not more than 1 MPa, and the surface of the light alloy member is then subjected to an anodizing treatment.

### TECHNICAL FIELD

The present invention relates to a surface-treated light alloy member and a method for manufacturing the same.

### BACKGROUND ART

Shot peening represents a known example of a surface modification method used for enhancing the fatigue strength of a metal material. Shot peening is a method wherein by impacting the surface of a metal material with countless particles having a particle size of approximately 0.8 mm (the shot material) together with a stream of compressed air, the hardness of the metal material surface is increased, and a layer having compressive stress is formed at a certain depth.

A method that uses a shot material containing microparticles that are much finer than conventional particles has been disclosed as a method of further enhancing the improvement in fatigue strength for an aluminum material obtained by shot peening treatment (see non-patent document 1).

Aluminum alloy members used as structural materials within the field of transportation machinery such as aircraft require a high degree of corrosion resistance, and because these members are used repeatedly, they also require a high degree of fatigue strength. However, because there is a limit to the levels of corrosion resistance and fatigue strength that can be achieved by relying solely on the properties of the alloy material itself, the application of a suitable surface treatment to further improve these properties has become very important.

Accordingly, aluminum alloy members that have undergone a shot peening treatment to increase the fatigue strength, and subsequently been subjected to an anodizing treatment (an anodic oxide coating treatment) to impart corrosion resistance are currently used as structural members within aircraft and various other types of transportation machinery.

Non-patent Document 1: Yasuhiro KATAOKA et al. “Surface Modification of Aluminum Alloys by Micro Particles Peening and Coating”, Research Report from Aichi Industrial Technology Institute (2002), Internet <URL: http://www.aichi inst.jp/html/reports/repo2002/r1-2.PDF>

### DISCLOSURE OF INVENTION

However, in a typical surface treatment method that combines a shot peening treatment and an anodizing treatment, the improvement in the fatigue life generated by the shot peening treatment is small, and when an aluminum alloy member that has undergone shot peening to increase the fatigue strength is subjected to an anodizing treatment, the fatigue strength actually deteriorates, meaning the effect of the shot peening treatment almost disappears.

The present invention takes these circumstances into consideration, with an object of providing a surface-treated light alloy member capable of achieving both favorable fatigue strength and favorable corrosion resistance, as well as a method for manufacturing such a surface-treated light alloy member.

In order to address the problems described above, the surface-treated light alloy member of the present invention and the method for manufacturing such a member adopt the means described below.

Namely, a method for manufacturing a surface-treated light alloy member according to the present invention comprises: a particle blowing treatment step, in which an air stream containing particles having an average particle size of not less than 10 μm and not more than 200 μm is blown onto the surface of a light alloy member at a spray pressure of not less than 0.2 MPa and not more than 1 MPa, and an anodizing treatment step in which the surface of the light alloy member is subjected to an anodizing treatment.

According to this method, the reduction in fatigue strength caused by the anodizing treatment is minimal, enabling the light alloy member to be imparted with both fatigue strength and corrosion resistance.

The light alloy member that functions as the target of the surface treatment of the present invention is preferably an aluminum alloy member. The reason for this preference is that of the various light alloys that can be subjected to anodizing, aluminum alloy is a particularly preferred material for structural members used within transportation machinery including aircraft.

In the above particle blowing treatment step, the coverage of the particle blowing treatment is preferably not less than 50% and not more than 1,000%.

By ensuring that the coverage of the particle blowing treatment falls within this range, the effect of the present invention in retaining a favorable fatigue strength can be satisfactorily achieved.

Following the particle blowing treatment step, and prior to the anodizing treatment step, a compressive stress of not less than 200 MPa preferably exists in the region within 5 μm of the surface of the light alloy member, and the ten-point mean roughness at the surface of the light alloy member is preferably less than 10 μm.

By ensuring that the properties of the light alloy member following completion of the particle blowing treatment step satisfy the ranges described above, the origin for fatigue failure of the light alloy member exists within the interior of the member, and consequently the fatigue strength is unlikely to decrease significantly, even following anodizing.

The above anodizing treatment can employ a boric acid-sulfuric acid anodizing treatment. A boric acid-sulfuric acid anodizing treatment is preferred in terms of its minimal impact on the environment, but has tended to cause a larger reduction in the fatigue strength than a conventional chromic acid anodizing treatment or sulfuric acid anodizing treatment. However, by using the method of the present invention, reduction in the fatigue strength can be prevented even when a boric acid-sulfuric acid anodizing treatment is used.

Furthermore, a light alloy member of the present invention is a light alloy member having an anodic oxide coating on the surface, wherein following the particle blowing treatment step described above, the surface ten-point mean roughness over at least a portion of the surface having an anodic oxide coating is not more than 10 μm, and a region having a compressive stress of not less than 300 MPa exists within 5 μm of at least a portion of the surface.

This light alloy member combines corrosion resistance and fatigue strength.

According to the present invention, a surface-treated light alloy member having both corrosion resistance and fatigue strength can be obtained.

### BRIEF DESCRIPTION OF DRAWINGS

FIG. 1 A graph showing the relationship between distance from the material surface and residual stress, for shot-peened test pieces from reference examples 1 to 3 and an untreated test piece.

FIG. 2 A graph (SN curves) showing the fatigue characteristics for test pieces from the reference examples 1 and 3, an example, comparative examples 1 and 2, and an untreated test piece.

FIG. 3 A scanning electron microscope (SEM) photograph of a fracture cross-section of a test piece of the reference example 1 (that has undergone shot-peening with microparticles).

FIG. 4 A scanning electron microscope (SEM) photograph of a fracture cross-section of a test piece of the example (that has undergone shot-peening with microparticles, followed by anodizing).

FIG. 5 A scanning electron microscope (SEM) photograph of a fracture cross-section of a test piece of the reference example 3 (that has undergone shot-peening with normal particles).

FIG. 6 A scanning electron microscope (SEM) photograph of a fracture cross-section of a test piece of the comparative example 1 (that has undergone shot-peening with normal particles, followed by anodizing).

FIG. 7 A scanning electron microscope (SEM) photograph of a fracture cross-section of a test piece of an untreated aluminum alloy member.

FIG. 8 A scanning electron microscope (SEM) photograph of a fracture cross-section of a test piece of the comparative example 2 (in which an untreated aluminum alloy member has been subjected to anodizing).

FIG. 9 A scanning electron microscope (SEM) photograph of the surface of a test piece of the reference example 1 (that has undergone shot-peening with microparticles).

FIG. 10 A scanning electron microscope (SEM) photograph of the surface of a test piece of the example (that has undergone shot-peening with microparticles, followed by anodizing).

FIG. 11 A scanning electron microscope (SEM) photograph of the surface of a test piece of the reference example 3 (that has undergone shot-peening with normal particles).

FIG. 12 A scanning electron microscope (SEM) photograph of the surface of a test piece of the comparative example 1 (that has undergone shot-peening with normal particles, followed by anodizing).

FIG. 13 A scanning electron microscope (SEM) photograph of the surface of a test piece of an untreated aluminum alloy member.

FIG. 14 A scanning electron microscope (SEM) photograph of the surface of a test piece of the comparative example 2 (in which an untreated aluminum alloy member has been subjected to anodizing).

### BEST MODE FOR CARRYING OUT THE INVENTION

As follows is a description of embodiments of a surface-treated light alloy member and a method for manufacturing such a member according to the present invention.

In a surface-treated light alloy member and a method for manufacturing such a member according to the present invention, the light alloy member used as the treatment target is a light alloy member that is able to be subjected to an anodizing treatment (an anodic oxide coating treatment), and is typically an aluminum alloy member. Embodiments that use an aluminum alloy member are described below, but the present invention is not restricted to these embodiments.

In a method for manufacturing a surface-treated light alloy member of the present invention, the particles (shot material) used in the particle blowing treatment (hereinafter referred to as the “shot peening treatment”) are hard particles of a metal, ceramic or glass or the like, and are preferably ceramic particles such as alumina or silica particles.

In conventional shot-peening treatments, a shot material with a particle size of approximately 0.8 mm is used, but in the present invention, particles of a size approximately 1/10th that of conventional shot materials, wherein the average particle size is not less than 10 μm and not more than 200 μm, and is preferably not less than 30 μm and not more than 100 μm, are used as the shot material. The reason that the particle size of the shot material was made smaller than conventional materials is based on a discovery made by the inventors of the present invention, which revealed that if a shot material having a particle size within the above range is used, and shot peening is conducted using a faster spray speed than conventional methods, then the fatigue life can be increased to a level 5 to 10 times that obtained by conventional shot peening, and the reduction in fatigue life caused by subsequent anodizing is minimal, meaning both superior fatigue life and a high degree of corrosion resistance can be achieved. If the size of the shot material particles is greater than 200 μm, then the excessively large kinetic energy of the particles causes damage to the material surface, meaning a satisfactory improvement in the fatigue life cannot be achieved. Furthermore, if the size of the shot material particles is smaller than 10 μm, then achieving a stable spray state becomes very difficult.

The spray speed of the shot material is regulated by the spray pressure of the compressed air stream. In a shot peening treatment of the present invention, the spray pressure is preferably not less than 0.1 MPa and not more than 1 MPa, and is even more preferably not less than 0.3 MPa and not more than 0.6 MPa. If the spray pressure is greater than 1 MPa, then the excessively large kinetic energy of the particles causes damage to the material surface, meaning a satisfactory improvement in the fatigue life cannot be achieved. Furthermore, if the spray pressure is less than 0.1 MPa, then achieving a stable spray state becomes very difficult.

The shot material particles are preferably spherical in shape. The reason for this preference is that if the shot material particles are sharp, then the surface of the aluminum alloy member may become damaged.

The coverage of the shot peening treatment is preferably within a range from 50 to 1,000%, and is even more preferably from 100 to 500%. At coverage levels of 50% or lower, a satisfactory improvement in fatigue strength cannot be obtained. Furthermore, coverage levels of 1,000% or higher are also undesirable, as the increase in temperature at the material surface causes a reduction in the compressive residual stress at the outermost surface, and a satisfactory improvement in fatigue strength cannot be obtained.

An aluminum alloy member that has been subjected to shot peening under the conditions described above preferably exhibits the surface properties described below.

(Surface Compressive Residual Stress and Depth)

A high compressive residual stress of not less than 200 MPa exists either at the outermost surface, or within the shallow region within 5 μm of the outermost surface. As a result, the surface is strengthened and fatigue failure occurs not at the surface, but within the interior of the material, meaning the fatigue life increases significantly.

In a conventional shot peening treatment, a high compressive residual stress exists within the interior of the material at least 50 μm from the surface, whereas the residual stress at the surface is actually quite small. Accordingly, fatigue failure tends to occur at the surface.

(Surface Roughness)

The surface roughness following shot peening, reported as a ten-point mean roughness Rz, is typically less than 10 μm, and is preferably less than 5 μm. Because this surface unevenness is very fine, the anodizing treatment of the subsequent step creates an even smoother surface.

In a conventional shot peening treatment, the surface is coarse, with a ten-point mean roughness Rz of approximately 50 μm, and this can cause damage to the surface (such as the occurrence of fine cracks or the like) and is one factor in the decrease in fatigue life. Coarse uneven portions formed on the material surface by conventional shot peening tend to be further emphasized by the subsequent anodizing treatment, creating a sensitized surface.

Subsequently, the aluminum alloy member that has undergone shot peening is subjected to an anodizing treatment. The anodizing treatment can employ the types of anodizing treatments typically conducted on light alloy members, and suitable examples include boric acid-sulfuric acid anodizing (BSAA) and chromic acid anodizing treatments. Boric acid-sulfuric acid anodizing is particularly preferred, as it has a minimal impact on the environment.

In this manner, by conducting shot peening and anodizing of an aluminum alloy member in a sequential manner and under the conditions described above, a surface-treated aluminum alloy member of the present invention can be obtained.

As follows is a more detailed description of the surface-treated light alloy member and method for manufacturing such a member according to the present invention, using a series of reference examples, an example, and comparative examples.

### REFERENCE EXAMPLE 1

The surface of a tensile fatigue test piece 15EA (a round bar test piece with a diameter of 6 mm at the measuring point) and a flat sheet test piece 5EA (30 mm×30 mm, thickness of 3 mm), both formed of an aluminum alloy material (JIS A7075-T6), were subjected to shot peening using a shot material comprising ceramic particles having an average particle size of 40 μm (hereinafter referred to as “microparticles”), under conditions including a spray pressure of 0.4 MPa and a coverage of 300%. The ten-point mean roughness Rz of the surface of the tensile fatigue test piece was 2.0 μm prior to the shot peening treatment, and 3.6 μm following the shot peening treatment.

### REFERENCE EXAMPLE 2

With the exception of altering the coverage to 3,000%, a tensile test piece 15EA and a flat sheet test piece 5EA of the aluminum alloy member were subjected to shot peening in the same manner as the reference example 1. The ten-point mean roughness Rz of the surface of the tensile fatigue test piece following the shot peening treatment was 6.1 μm.

### REFERENCE EXAMPLE 3

The surfaces of test pieces of the same shape and same material as those described in the reference examples 1 and 2 were subjected to shot peening using a shot material comprising cast steel particles having an average particle size of 300 μm (hereinafter referred to as “normal particles”), under conditions including a spray pressure of 0.3 MPa and a coverage of 100%. The ten-point mean roughness Rz of the surface of the tensile fatigue test piece following the shot peening treatment was 46.7 μm.

(Measurement of Near-Surface Residual Stress following Shot Peening)

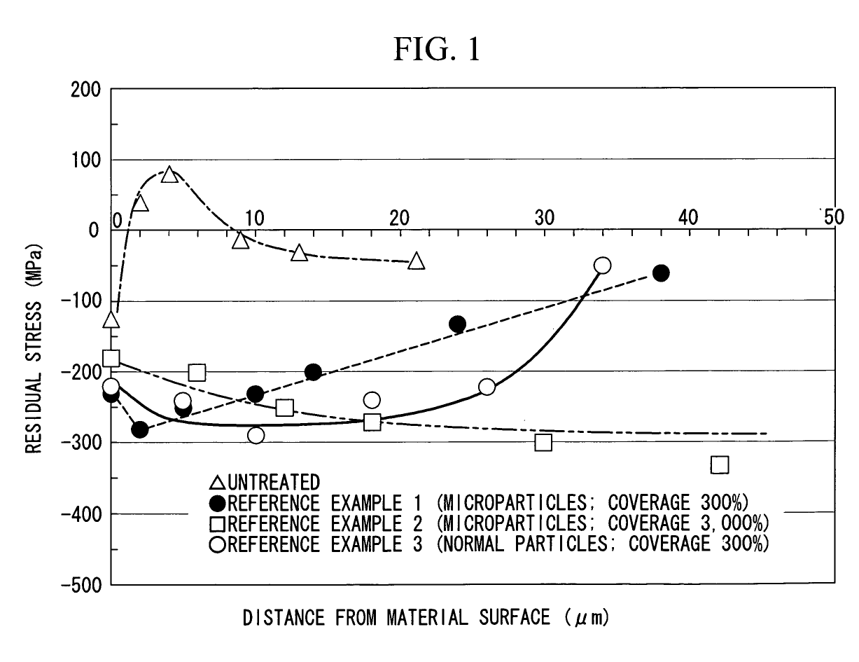

Using the flat sheet test pieces subjected to shot peening at the same time as the tensile fatigue test pieces in the reference examples 1 to 3, and an untreated flat sheet test piece, the relationship between distance from the material surface and residual stress was investigated. The results are shown in FIG. 1.

From FIG. 1 it is evident that in the reference examples 1 and 2, where the shot peening treatment was conducted using microparticles, a high degree of compressive residual stress of not less than 200 MPa exists within the shallow region within 5 μm of the outermost surface.

In contrast, in the reference example 3, where the shot peening treatment was conducted using normal particles, it is clear that a high degree of compressive residual stress exists within the interior of the material, at least 50 μm from the outermost surface.

The compressive residual stress at the outermost surface of each test piece was as shown below.

Untreated: −120 MPa

Reference Example 1 (microparticles; coverage 300%): −230 MPa

Reference Example 2 (microparticles; coverage 3,000%): −220 MPa

Reference Example 3 (normal particles; coverage 300%): −180 MPa

### EXAMPLE, AND COMPARATIVE EXAMPLES 1 and 2

Aluminum alloy member test pieces from the reference example 1 (microparticles; coverage 300%) and the reference example 3 (normal particles; coverage 3,000%), together with an untreated test piece, were subjected to a boric acid-sulfuric acid anodizing treatment (BSAA), and the resulting pieces were used as test pieces for the example and the comparative examples 1 and 2 respectively. This boric acid-sulfuric acid anodizing treatment involves sequentially conducting steps for solvent degreasing, alkali immersion degreasing, water washing, deoxidizing, water washing, boric acid-sulfuric acid treatment, water washing, and dilute sealing.

Although the above treatment conditions were the same for the tensile test pieces and the flat sheet test pieces, the anodizing of the tensile test pieces and flat sheet test pieces were conducted using different electrobaths. The electrical current during anodizing of the tensile test pieces was 8 A, whereas the electrical current during anodizing of the flat sheet test pieces was 7 A.

(Measurement of Surface Residual Stress following Anodizing)

Following the boric acid-sulfuric acid anodizing treatment, measurement of the residual stress at the outermost surface of the flat sheet test pieces from the example and the comparative example 1 revealed the results shown below. Example (shot peening with microparticles+anodizing): −760 MPa

Comparative example 1 (shot peening with normal particles+anodizing): −225 MPa

As described above, it was known that conducting boric acid-sulfuric acid anodizing lead to an increase in the surface compressive residual stress, but in the example, where the anodizing treatment was conducted following shot peening with microparticles, a dramatic increase of at least 3-fold was observed compared with the reference example 1 that represents the case prior to anodizing.

As described below, it is thought that his large increase in the compressive residual stress is a major factor in the superior fatigue life observed following the boric acid-sulfuric acid anodizing treatment.

(Tensile Fatigue Life Testing)

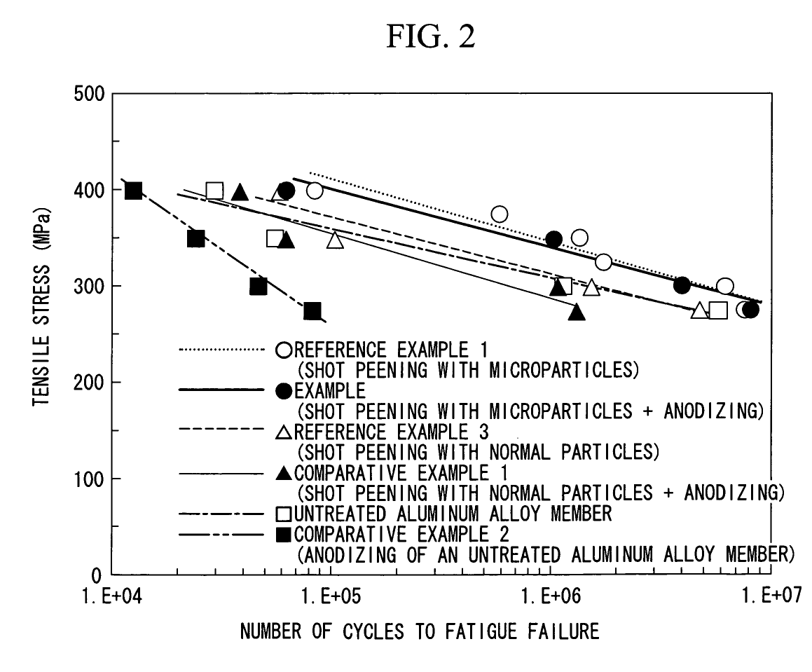

Tensile test pieces (smooth round bar test pieces) of the reference example 1 (shot peening with microparticles), the example (shot peening with microparticles followed by anodizing), the reference example 3 (shot peening with normal particles), the comparative example 1 (shot peening with normal particles followed by anodizing), an untreated aluminum alloy member, and the comparative example 2 (anodizing of an untreated aluminum alloy member) were each subjected to tensile fatigue testing, and the number of cycles to failure (the tensile fatigue life) was measured. FIG. 2 is a graph (SN curves) showing the results of the measurements.

The tensile fatigue life results obtained at a tensile stress of 350 MPa were as shown below.
Reference example 1 (shot peening with microparticles):
1,371,367 cycles
Example (shot peening with microparticles+anodizing):
1,059,348 cycles
Reference example 3 (shot peening with normal particles):
121,127 cycles
Comparative example 1 (shot peening with normal particles+anodizing):
62,809 cycles
Untreated aluminum alloy member: 56,103 cycles
Comparative example 2 (anodizing of an untreated aluminum alloy member): 24,492 cycles

From FIG. 2 it is evident that the SN curve for the reference example 1 and the SN curve for the example lie along almost the same line. In other words, it is evident that the example of the present invention, wherein anodizing treatment was conducted following shot peening with microparticles, exhibits a significant improvement in fatigue life beyond that of the comparative example 1, where anodizing treatment was conducted following shot peening with normal particles, and also suffers almost no reduction in the fatigue life as a result of the anodizing treatment. Accordingly, in this example, the improvement in the fatigue life provided by the shot peening treatment can be duly considered during member design.

Conventionally, it has been thought that any improvement in fatigue life generated by shot peening is substantially reduced during the anodizing treatment, and the observation that shot peening with microparticles conducted under the conditions prescribed in the present invention results in almost no reduction in fatigue life caused by the anodizing treatment represents a finding first made by the inventors of the present invention.

In contrast, it is evident that in the comparative example 1, the increase in fatigue life arising from the shot peening treatment is minimal, and furthermore, the anodizing treatment causes a significant reduction in this fatigue life, with the fatigue life falling further than the case of the untreated aluminum alloy member. In other words, in the case of a combination of a shot peening treatment using normal particles and an anodizing treatment, any improvement in fatigue life provided by the shot peening treatment can certainly not be considered during member design, and in actual fact, a reduction in fatigue life must be taken into consideration.

(Scanning Electron Microscopes of Fracture Cross-sections and Surfaces)

Scanning electron microscope photographs of fracture cross-sections:

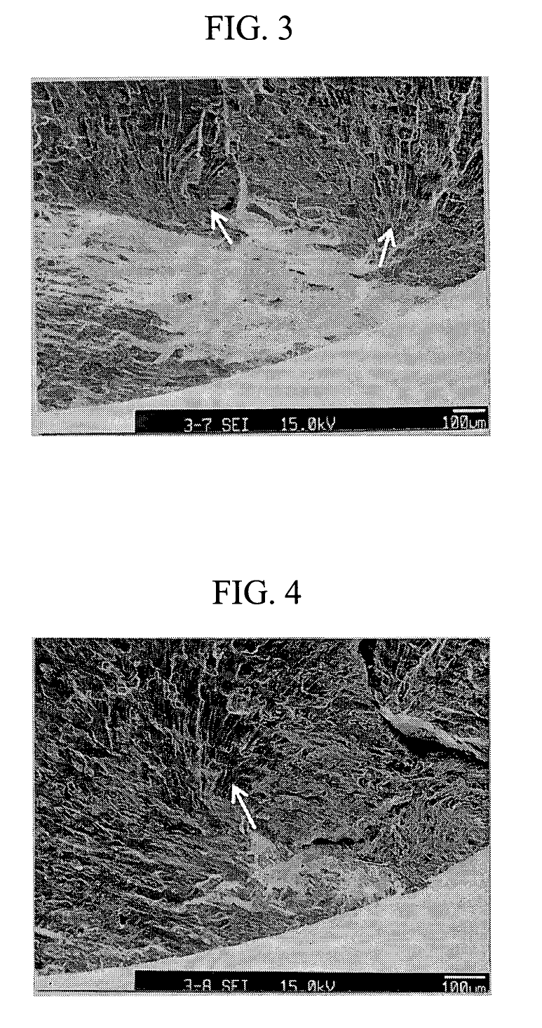

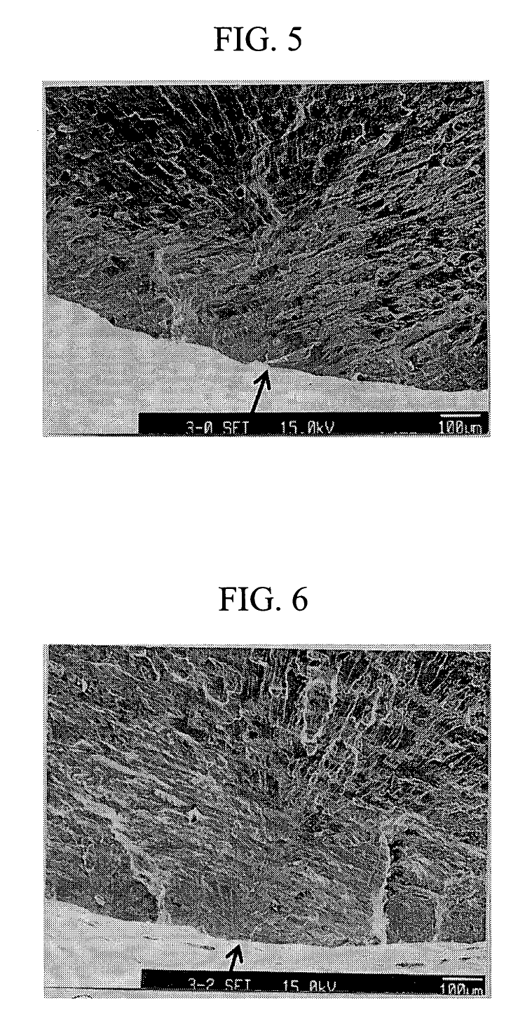

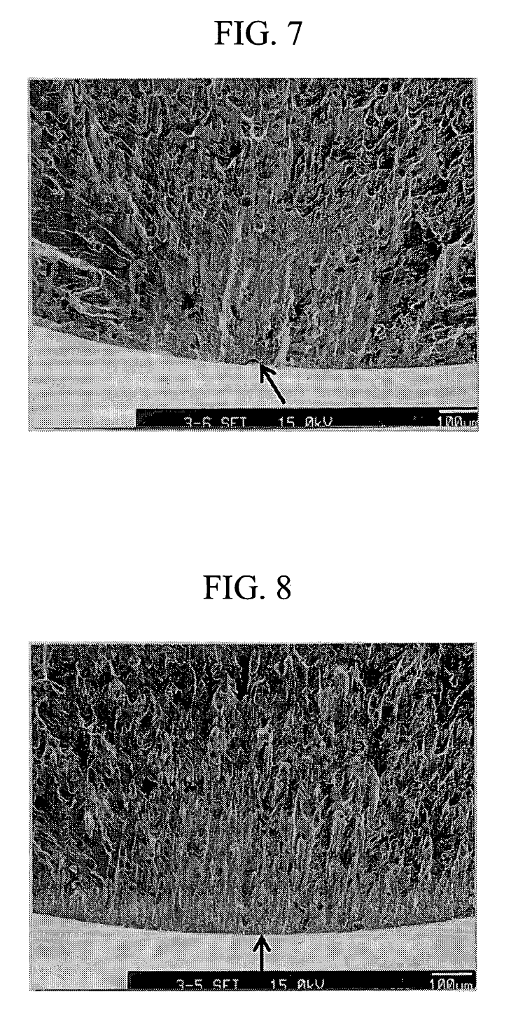

FIG. 3 through FIG. 8 show scanning electron microscope (SEM) photographs of fracture cross-sections of the tensile fatigue test pieces, wherein FIG. 3 shows the test piece of the reference example 1 (shot peening with microparticles), FIG. 4 shows the test piece of the example (shot peening with microparticles followed by anodizing), FIG. 5 shows the test piece of the reference example 3 (shot peening with normal particles), FIG. 6 shows the test piece of the comparative example 1 (shot peening with normal particles followed by anodizing), FIG. 7 shows the untreated aluminum alloy member, and FIG. 8 shows the test piece of the comparative example 2 (anodizing of an untreated aluminum alloy member). In each photograph, an arrow is used to show the failure origin, and the direction of the failure.

From FIG. 3 it is evident that in the reference example 1, where shot peening was conducted using microparticles, the shot peening treatment has strengthened the surface, meaning the failure origin occurs within the interior of the material. In a similar manner, it is evident from FIG. 4 that in the example, where the shot peening treatment with microparticles was followed by a boric acid-sulfuric acid anodizing treatment, the failure origin once again occurs within the interior of the material.

In a manner of speaking, the surface can be considered a defect that represents a weakened portion, and consequently, failure of the material usually starts at the surface. However, following shot peening with microparticles, a high degree of compressive residual stress of not less than 200 MPa exists in the shallow region within 5 μm of the outermost surface, and this causes the failure origin to shift to defective regions (such as inclusions) within the interior of the material. This failure within the material interior is the cause of the extended lifespan.

In contrast, it is evident from FIG. 5 and FIG. 6 that in the test pieces that were subjected to shot peening with normal particles, failure starts at the surface regardless of whether or not an anodizing treatment is conducted.

It is thought that following shot peening with normal particles, because high compressive residual stress exists within the interior of the material at least 50 μm from the surface, fatigue failure starts at the surface. Furthermore, it is also thought that this results in a shortened fatigue life.

Furthermore, it is evident from FIG. 7 and FIG. 8 that in the test pieces that have not undergone shot peening, surface strengthening has not occurred, and consequently failure starts at the surface regardless of whether or not an anodizing treatment is conducted. It is thought that this results in a shortened fatigue life.

Scanning electron microscope photographs of surfaces:

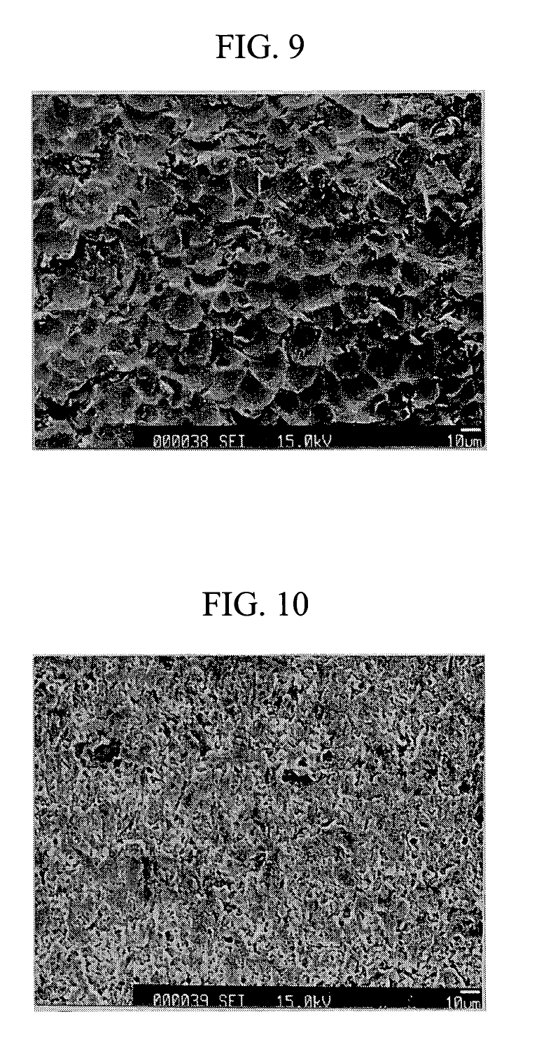

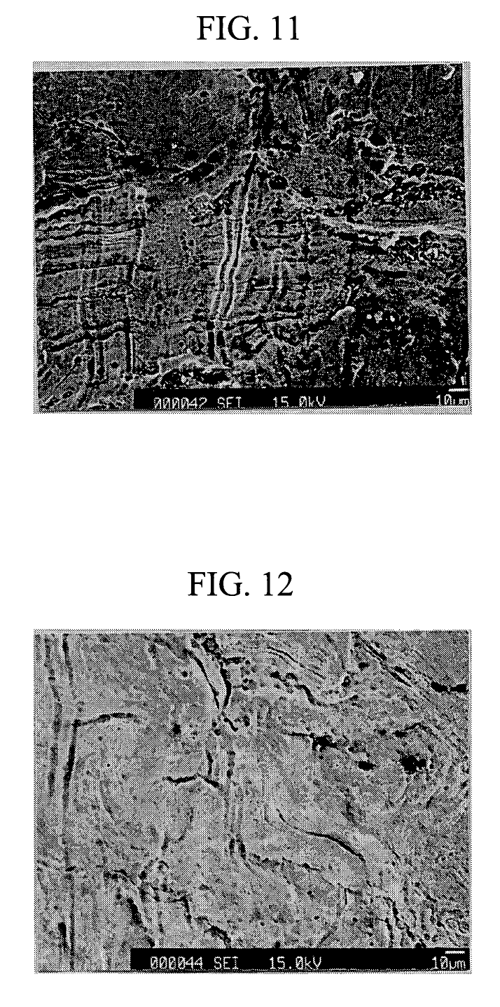

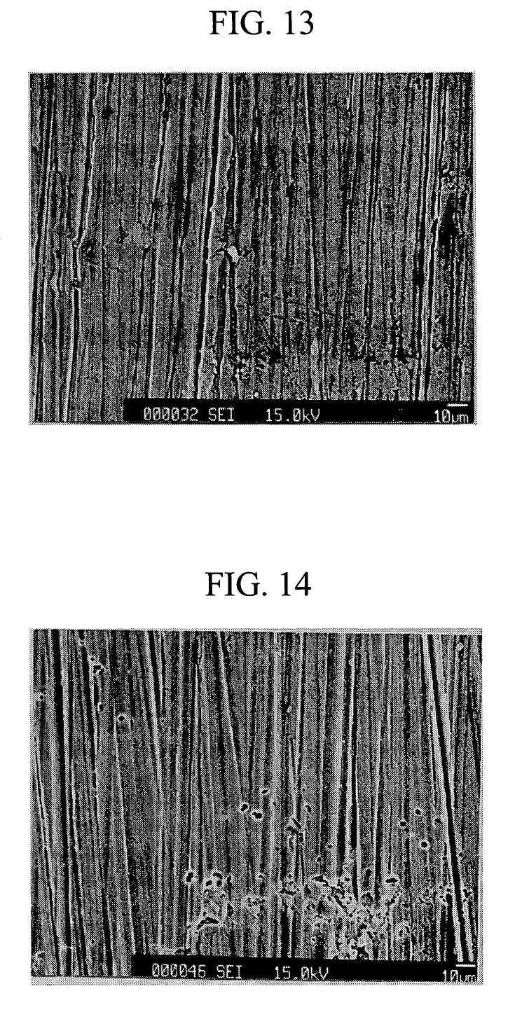

FIG. 9 through FIG. 14 are scanning electron microscope (SEM) photographs of the surfaces of the tensile fatigue test pieces, wherein FIG. 9 shows the test piece of the reference example 1 (shot peening with microparticles), FIG. 10 shows the test piece of the example (shot peening with microparticles followed by anodizing), FIG. 11 shows the test piece of the reference example 3 (shot peening with normal particles), FIG. 12 shows the test piece of the comparative example 1 (shot peening with normal particles followed by anodizing), FIG. 13 shows the untreated aluminum alloy member, and FIG. 14 shows the test piece of the comparative example 2 (anodizing of an untreated aluminum alloy member).

The fine dimple pattern generated by shot peening with microparticles (FIG. 9) is smoothed by the anodizing treatment (FIG. 10). It is thought that because the anodizing treatment involves a chemical reaction within a solution, a partial dissolution phenomenon occurs at the surface. This type of smooth surface has a longer fatigue life (assuming other factors such as the compressive stress are the same), and consequently represents a preferred state.

In contrast, shot peening with normal particles generates a rough surface with a ten-point mean roughness Rz of approximately 50 μm, and as a result, tends to cause surface damage (such as the generation of fine cracks) that is one factor in a reduction in the fatigue life (FIG. 11). Even if an anodizing treatment is conducted, this damage either remains substantially unchanged, or may even be emphasized by anodizing, meaning a sensitized surface results (FIG. 12). It is surmised that the partial dissolution phenomenon caused by the anodizing treatment is unable to remove the large-scale damage caused by the shot peening treatment with normal particles. Furthermore, it is thought that because these sites of large-scale damage, which are hardened by the anodizing treatment, act as points of origin for fatigue failure, the fatigue life actually deteriorates following the anodizing treatment.

### INDUSTRIAL APPLICABILITY

A surface-treated light alloy member produced by a manufacturing method of the present invention can be used favorably as a structural member within the field of transportation machinery including aircraft and automobiles.

1. A method for manufacturing a surface-treated light alloy member, comprising:
a particle blowing treatment step, in which an air stream containing particles having an average particle size of not less than 10 μm and not more than 200 μm is blown onto a surface of a light alloy member at a spray pressure of not less than 0.1 MPa and not more than 1 MPa, and
an anodizing treatment step in which the surface of the light alloy member is subjected to an anodizing treatment.

2. The method for manufacturing a surface-treated light alloy member according to claim 1, wherein the light alloy member comprises an aluminum alloy.

3. The method for manufacturing a surface-treated light alloy member according to claim 1, wherein coverage of a particle blowing treatment conducted during the particle blowing treatment step is not less than 50% and not more than 1,000%.

4. The method for manufacturing a surface-treated light alloy member according to claim 1
wherein
following the particle blowing treatment step and prior to the anodizing treatment step, a compressive stress of not less than 200 MPa exists in a region within 5 μm of a surface of the light alloy member.

5. The method for manufacturing a surface-treated light alloy member according to claim 1, wherein
following the particle blowing treatment step and prior to the anodizing treatment step, a ten-point mean roughness at a surface of the light alloy member is less than 10 μm.

6. The method for manufacturing a surface-treated light alloy member according to claim 1, wherein
the anodizing treatment is a boric acid-sulfuric acid anodizing treatment.

7. A light alloy member having an anodic oxide coating on a surface thereof, wherein
a surface ten-point mean roughness over at least a portion of the surface having the anodic oxide coating is not more than 10 μm, and a region having a compressive stress of not less than 300 MPa exists within 5 μm of at least a portion of the surface.
